(19) United States
(12) Patent Application Publication
(10) Pub. No.: US 2026/0212857 A1
(43) Pub. Date: Jul. 23, 2026

(54) METHOD AND SYSTEM FOR ASSIGNING SYNTHESIZED VOICE STYLES TO DIFFERENT CHARACTERS, AND COMPUTER PROGRAM PRODUCT FOR IMPLEMENTING THE METHOD

(71) Applicant: UDN DIGITAL CO., LTD., New Taipei City (TW)

(72) Inventor: Chia-Ruei LIAN, Yilan City (TW)

(73) Assignee: UDN DIGITAL CO., LTD., New Taipei City (TW)

(21) Appl. No.: 19/035,192

(22) Filed: Jan. 23, 2025

(51) Int. Cl. G10L 13/027

(52) U.S. Cl. CPC G10L 13/027

(57) ABSTRACT

A method for assigning synthesized voice styles to different characters includes: obtaining a voice style requirement file and a list of voice style groups, wherein the voice style requirement file includes a plurality of character profiles, each including a character mark, and the list of voice style groups includes a plurality of voice style groups, each being associated with one character mark, and including plural entries of voice style data, each of the entries of voice style data being associated with a voice style; and for each of the character profiles, selecting one of the voice style groups as a matching voice style group, and then assigning one of the entries of voice style data included in the matching voice style group to the character profile.

### FIELD

The disclosure relates to a method and a system for assigning synthesized voice styles, and more particularly to a method and a system for assigning synthesized voice styles to different characters. The disclosure further relates to a computer program product for implementing the method.

### BACKGROUND

In the field of voice dubbing for a text file (e.g., a novel) or a video (e.g., a movie) that involves a plurality of characters, each of the plurality of characters is typically assigned to a unique voice style. As the computer science advances, the synthesized speech voice has become available for voice dubbing.

The commercially available software that offers text-to-speech (TTS) service may provide multiple different voice styles for different uses. It is noted that in the case of dubbing a more complicated text file (e.g., a novel, a play, etc.), a large number of characters may be present. Additionally, it is generally advised to avoid using voice styles that are considered “sticking out,” such as voices with a heavy accent. As such, some of the voice styles provided by the commercially available software may not be suitable for dubbing, and the number of suitable voice styles may be limited, which is a particularly crucial issue in the cases where the number of characters that need dubbing is relatively large.

### SUMMARY

Therefore, an object of the disclosure is to provide a method that can alleviate at least one of the drawbacks of the prior art.

According to one embodiment of the disclosure, the method for assigning synthesized voice styles to different characters is implemented using a system that includes a processor. The method includes:
a) obtaining a voice style requirement file and a list of voice style groups, wherein
   the voice style requirement file includes a plurality of character profiles that respectively correspond with a plurality of characters included in a text file, and each of the plurality of character profiles includes a character mark that indicates a type of the respective one of the plurality of characters, and
   the list of voice style groups includes a plurality of voice style groups, each of the plurality of voice style groups is associated with one of the character marks of the plurality of character profiles, and includes plural entries of voice style data, each of the plural entries of voice style data is associated with a voice style, and for at least one of the plurality of voice style groups, the plural entries of voice style data include one initial entry of voice style data and at least one derived entry of voice style data that is obtained by performing an audio pitch adjustment operation on the initial entry of voice style data; and
b) establishing an association between each of the plurality of characters included in the text file and a voice style by, for each of the plurality of character profiles, selecting one of the plurality of voice style groups that is associated with the character mark of the character profile as a matching voice style group, and then assigning one of the plural entries of voice style data included in the matching voice style group to the character profile.

Another object of the disclosure is to provide a system that is configured to implement the above-mentioned method.

According to one embodiment of the disclosure, the system includes a processor and a data storage unit that is connected to the processor and that stores a software application therein. The processor executing the software application is programmed to perform the steps of the above-mentioned method.

Yet another object of the disclosure is to provide a computer program product that is configured to implement the steps of above-mentioned method.

According to one embodiment of the disclosure, the computer program product includes a software program that is stored in a non-transitory storage medium and that includes instructions, which can be loaded and executed by a processor of an electronic device. When executed by the processor, the instructions cause the processor to implement the steps of above-mentioned method.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating components of a system for assigning synthesized voice styles to different characters according to one embodiment of the disclosure.

FIG. 2 is a flow chart illustrating steps of a method for assigning synthesized voice styles to different characters according to one embodiment of the disclosure.

FIG. 3 illustrates an exemplary voice style requirement file according to one embodiment of the disclosure.

FIG. 4 illustrates an exemplary list of voice style groups according to one embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

Throughout the disclosure, the term “voice style” refers to a unique computer-generated voice that incorporates a specific set of acoustic characteristics such as audio pitches, timbre, accents (intonation), tempo, etc. The term “timbre” refers to a distinguishable quality of the voice that enables listeners to distinguish two different voice styles even with the same loudness and the same pitch.

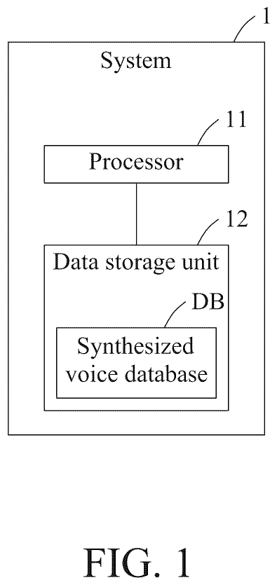

FIG. 1 is a block diagram illustrating components of a system 1 for assigning synthesized voice styles to different characters according to one embodiment of the disclosure. In some embodiments, the system 1 may be embodied using a computer device such as a server, a personal computer, a laptop, a tablet, a smartphone, etc. The system 1 includes a processor 11 and a data storage unit 12 connected to the processor 11.

In embodiments, the processor 11 may be embodied using one or more of a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application-specific integrated circuit (ASIC), a radio-frequency integrated circuit (RFIC), etc. Generally, the processor 11 is embodied using components that include computation and instruction processing capabilities.

The data storage unit 12 is connected to the processor 11, and may be embodied using, for example, one or more of random access memory (RAM), read only memory (ROM), programmable ROM (PROM), firmware, flash memory, etc. In this embodiment, the data storage unit 12 stores a computer program product including instructions that, when executed by the processor 11, cause the processor 11 to implement the operations as described below.

It is noted that in other embodiments, the processor 11 may be an assembly of a plurality of the above mentioned components, or circuitry that includes one or more of the above mentioned components. The data storage unit 12 may be an assembly of one or more of the above mentioned components.

The data storage unit 12 further stores a synthesized voice database (DB). In use, the synthesized voice database (DB) may be established by the processor 11 executing a commercially available voice synthesization software, and includes a plurality of voice setting profiles that correspond with a plurality of virtual voices. In use, each of the voice setting profiles enables a speaker (not depicted in the drawings) to output speeches in the corresponding virtual voice. That is to say, when provided with text and a selected one of the voice setting profiles, the processor 11 is configured to control the speaker to output a speech of the text using the corresponding virtual voice. It is noted that the technique of the voice synthesization software and the voice setting profiles are readily available in the related art, and therefore details thereof are omitted herein for the sake of brevity.

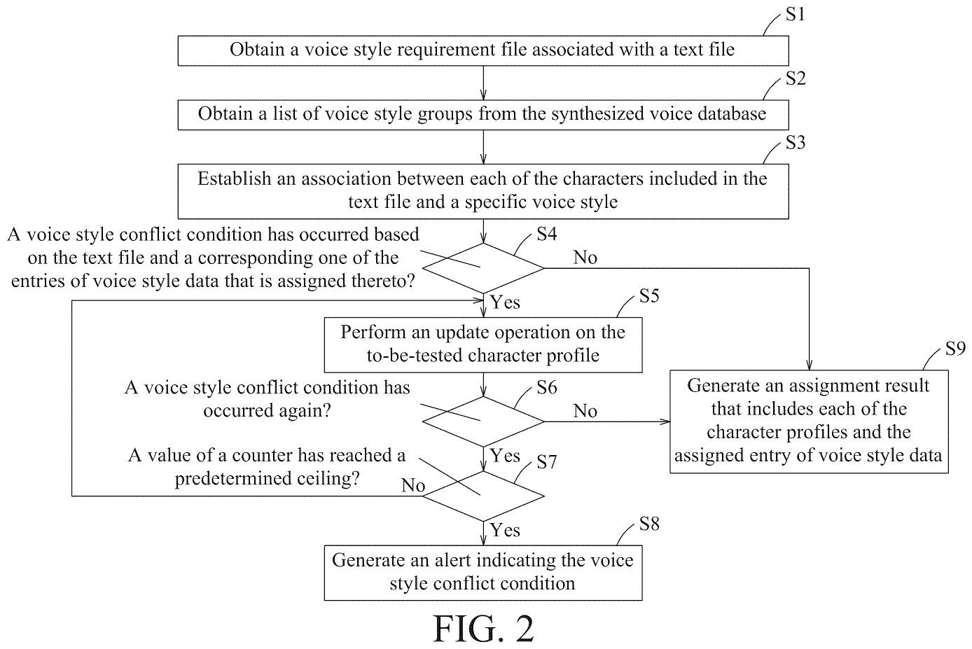

FIG. 2 is a flow chart illustrating steps of a method for assigning synthesized voice styles to different characters according to one embodiment of the disclosure. In this embodiment, the method is implemented using the system 1 as shown in FIG. 1.

In use, a user may operate the system 1 to execute the software application installed in the system 1 to initiate the method. Then, in step S1, the processor 11 obtains a text file for dubbing and a voice style requirement file associated with the text file. In embodiments, the text file may be pre-stored in the data storage unit 12 or obtained from a remote server via a network (e.g., the Internet) or from an externally connected data storage device (e.g., a flash drive).

In embodiments, the text file may contain text of a work such as a novel, a play, etc., and the content of the text file indicates a plurality of characters and a plurality of spoken lines. Each of the spoken lines may be attributed to one of the plurality of characters in a conversation or a monologue, and may include sentences represented using a natural language.

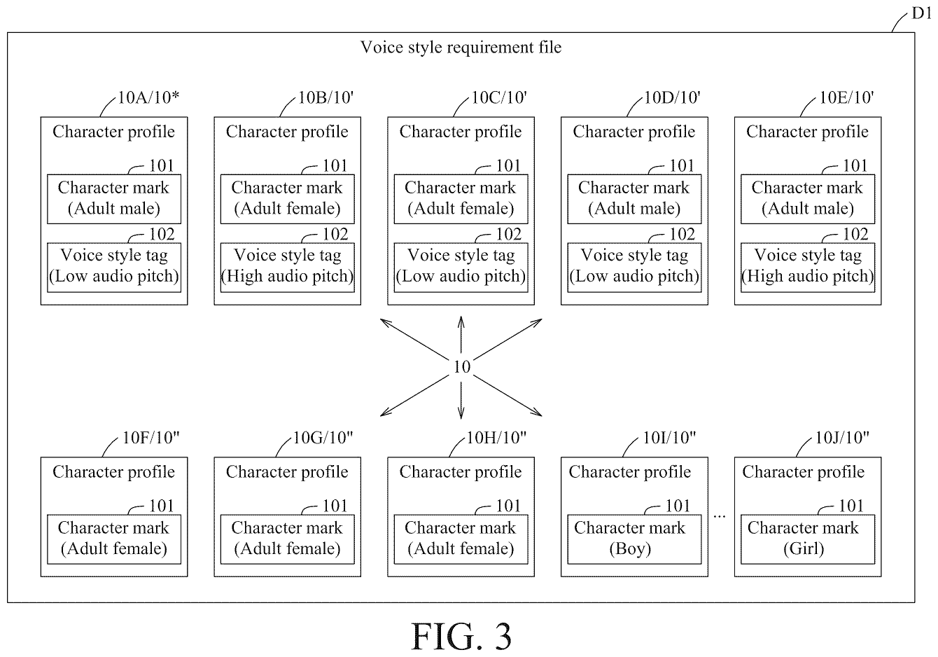

FIG. 3 illustrates an exemplary voice style requirement file D1. The voice style requirement file D1 includes a plurality of character profiles 10 that correspond with the plurality of characters included in the text file. In the example of FIG. 3, ten character profiles 10 (labeled as 10A to 10J) are present, but in other embodiments, other numbers of character profiles 10 may be present.

Each of the plurality of character profiles 10 may be in a specific format as shown in FIG. 3. Specifically, each of the plurality of character profiles 10 includes a character mark 101 that indicates a certain type of the character such as “adult male,” “adult female,” “boy,” “girl,” etc., but other kinds of character marks may be employed. It is noted that in different implementations, multiple character profiles 10 may include the character marks 101 that are the same. In the example of FIG. 3, the character profiles 10A, 10D and 10E all include the same character marks 101 indicating “adult male.”

In embodiments, some of the plurality of character profiles 10 (e.g., the character profiles 10A to 10E shown in FIG. 3) may further include voice style tags 102. In the example of FIG. 3, the voice style tag 102 indicates a certain audio pitch related to the voice of the character, such as “high pitch,” “middle pitch” and “low pitch,” but other kinds of voice style tags may be employed to specify different acoustic characteristics. In the example of FIG. 3, the voice style tag 102 included in the character profile 10B indicates a high pitch, indicating that it is preferable that the character associated with the character profile 10B is to be dubbed using a voice style of “adult female with a high pitch.” It is noted that the number of character profiles 10 that include the voice style tags 102 is not limited to such.

In some embodiments, one or more of the plurality of character profiles 10 may be assigned with a lead status, indicating that the associated character(s) may be lead character(s) or a narrator. In the example of FIG. 3, the character profile 10A is assigned with the lead status, and may be labeled as 10* to indicate that the associated character is a male lead character, but the number of character profiles 10 that can be assigned with the lead status is not limited to such.

Further, one or more of the plurality of character profiles 10 may be assigned with a primary support status, indicating that the associated character(s) may be supporting character(s) that are relatively important (e.g., with more spoken lines). In the example of FIG. 3, the character profiles 10B to 10E are assigned with the primary support status, and may be labeled as 10′ to indicate that the associated characters are supporting characters with more spoken lines, but the number of character profiles 10 that can be assigned with the primary support status is not limited to such.

Further, one or more of the plurality of character profiles 10 may be assigned with a secondary support status, indicating that the associated character(s) may be supporting character(s) that are relatively less important (e.g., with few spoken lines). In the example of FIG. 3, the character profiles 10 that do not include voice style tags 102 (e.g., 10F to 10J) are assigned with the secondary support status, and may be labeled as 10″ to indicate that the associated characters are supporting characters with few spoken lines, but the number of character profiles 10 that can be assigned with the secondary support status is not limited to such.

In embodiments, the voice style requirement file D1 may be obtained by the processor 11 executing a large language model (LLM) to segment the text file and perform natural language processing to identify the characters included in the text file, and to determine, for each of the characters, a suitable character profile, in order to create the voice style requirement file D1. Alternatively, the voice style requirement file D1 may be manually created by a user who determines the suitable character profile for each of the characters, and operates the system 1 to manually create the voice style requirement file D1. Alternatively, the voice style requirement file D1 may be obtained from a remote server via the network (e.g., the Internet) or from the externally connected data storage device (e.g., a flash drive).

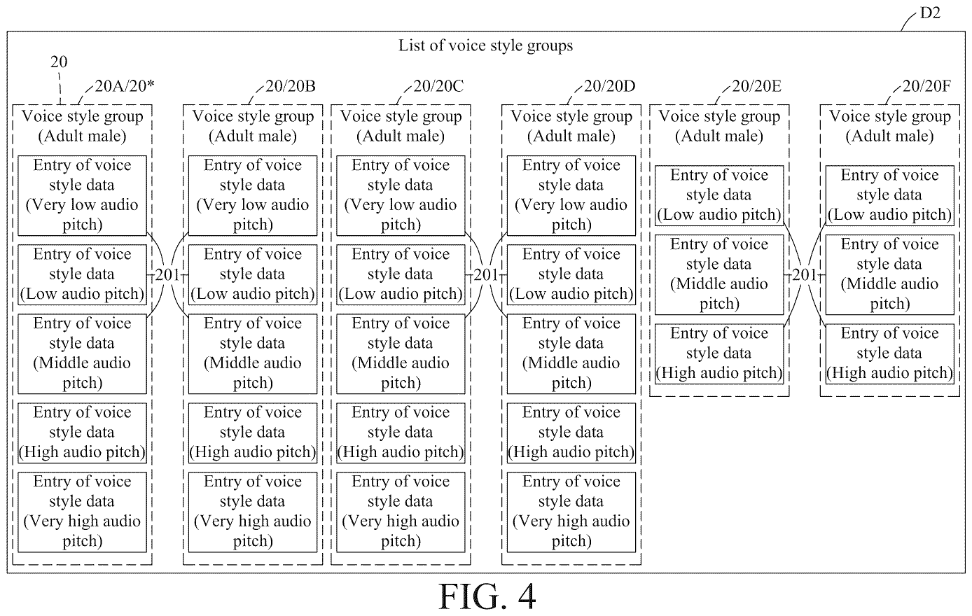

After the text file and the voice style requirement file D1 are obtained in step S1, the flow proceeds to step S2, in which the processor 11 obtains a list of voice style groups from the synthesized voice database (DB). FIG. 4 illustrates an exemplary list of voice style groups D2 according to one embodiment of the disclosure.

As shown in FIG. 4, the list of voice style groups D2 includes a plurality of voice style groups 20 (in the example of FIG. 4, six voice style groups 20 are present and are labeled as 20A to 20F, but the disclosure is not limited to such). Each of the voice style groups 20 is correspondingly associated with one of the character marks 101 that indicates a certain type of the character such as “adult male,” “adult female,” “boy,” “girl,” etc. In the example of FIG. 4, the association between each of the voice style groups 20 and the corresponding one of the character marks 101 may be preset.

For each of the voice style groups 20, plural entries of voice style data 201 are included, each of the entries of voice style data 201 being associated with a specific voice style. The entries of voice style data 201 included in a same voice style group 20 are associated with a voice style that is suitable for dubbing a character that has the corresponding one of the character marks 101. For example, the voice style group 20A is associated with the character mark 101 indicating “adult male,” and includes five entries of voice style data 201. Each of the five entries of voice style data 201 included in the voice style group 20A therefore are suitable for dubbing an adult male character, and are different from one another. In use, each of the entries of voice style data 201 may be in the form of a plurality of different phonetic parameters that defines a specific set of phonetic characteristics such as audio pitches, timbre, accent (intonation), tempo, etc. That is to say, when provided with text and a selected one of the entries of voice style data 201, the processor 11 controls the speaker to output a speech of the text with the specific set of phonetic characteristics indicated by the selected one of the entries of voice style data 201.

In some embodiments, the entries of voice style data 201 included in same voice style group 20 may all reflect a specific accent, and are different from one another in at least the audio pitches. That is to say, with respect to text and one of the voice style groups 20, a number of speeches of the text with a same accent in different audio pitches may be generated based on the entries of voice style data 201 included in the one of the voice style groups 20.

Such a voice style group 20 may be created by first extracting a specific voice setting profile from the synthesized voice database (DB) as an initial entry of voice style data 201, and using the initial entry of voice style data 201 to perform an audio pitch adjustment operation (to adjust the relevant parameters, so as to raise or lower the audio pitch) to obtain one or more of new entry(ies) of voice style data 201. That is to say, other than the initial entry of voice style data 201, each of the remaining entries of voice style data 201 may be a derived entry of voice style data 201, and is derived by the processor 11 performing the audio pitch adjustment operation based on the initial entry of voice style data 201. Generally, in embodiments, at least one of the plurality of voice style groups 20 includes one initial entry of voice style data 201 extracted from the synthesized voice database (DB), and at least one derived entry of voice style data 201 obtained by performing the audio pitch adjustment operation on the initial entry of voice style data 201.

Using the example of FIG. 4, the voice style group 20A includes an initial entry of voice style data 201 that has a middle audio pitch, and that is extracted from the synthesized voice database (DB). Using the audio pitch adjustment operation based on the initial entry of voice style data 201, two other entries of voice style data 201 may be derived by lowering the audio pitch (e.g., the entries of voice style data 201 labeled as “low audio pitch” and “very low audio pitch”), and two other entries of voice style data 201 may be derived by raising the audio pitch (e.g., the entries of voice style data 201 labeled as “high audio pitch” and “very high audio pitch”). As such, by extracting a single voice setting profile from the synthesized voice database (DB), a voice style group 20 including different entries of voice style data 201 may be created. In this manner, the number of suitable entries of voice style data 201 may be increased for dubbing the characters.

In some embodiments, a derived entry of voice style data 201 may further used in another voice style group 20 as an initial entry of voice style data 201. For example, in the example of FIG. 4, one of the voice style groups 20C is associated with one of the character marks 101 that indicates “adult female.” Using one of the entries of voice style data 201 included in the voice style group 20C (e.g., the initial entry of voice style data 201), the processor 11 may perform the audio pitch adjustment operation to raise the audio pitch so as to generate a derived entry of voice style data 201, and to use the derived entry of voice style data 201 as an initial entry of voice style data 201 of another voice style group 20 (e.g., the voice style group 20E, which is associated with one of the character marks 101 that indicates “boy”). In this manner, additional voice style group(s) 20 with suitable voices may be created, and the number of suitable entries of voice style data 201 may be further increased for dubbing different characters.

It is noted that in different examples, each of the voice style group 20 may include different numbers of entries of voice style data 201. For example, in the example of FIG. 4, the voice style group 20E includes three entries of voice style data 201, and in some embodiments, some voice style groups 20 may include other numbers of entries of voice style data 201, such as one. In some embodiments, in addition to the audio pitch adjustment operation, an additional derived entry of voice style data 201 may be generated by further performing a tempo adjustment operation to adjust a tempo of the speech associated with the derived entry of voice style data 201.

In some embodiments, depending on the voice style requirement file D1, the need for dubbing associated with characters having some of the same character marks 101 may be large, and different voice style groups 20 that are associated with the character marks 101 that are the same may be present. In the example of FIG. 4, two voice style groups 20 (e.g., the voice style groups 20A and 20B) are associated with the adult male characters, and two voice style groups 20 (e.g., the voice style groups 20C and 20D) are associated with the adult female characters. In this configuration, while two of the voice style groups 20 (e.g., the voice style groups 20A and 20B) are associated with the same character marks 101, with respect to the two different voice style groups 20, the resulting voice styles differ in terms of at least the accent or the timbre. Additionally, within all of the voice style groups 20, each of the entries of voice style data 201 is unique in the combination of the audio pitch, the accent, the tempo and the timbre.

After the list of voice style groups D2 is obtained in step S2, the step proceeds to step S3.

In step S3, the processor 11 establishes an association between each of the characters included in the text file and a specific voice style. That is to say, the operations of step S3 is to, for each of the character profiles 10 included in the voice style requirement file D1, select one of the voice style groups 20 as a matching voice style group, and then assign one of the entries of voice style data 201 included in the matching voice style group to the character profile 10.

In some embodiments, the operations of step S3 may be first performed with respect to the character profile(s) 10* that is(are) assigned with the lead status by assigning the suitable entry(entries) of voice style data 201 thereto, then be performed with respect to the character profile(s) 10′ that is(are) assigned with the primary support status by assigning the suitable entry(entries) of voice style data 201 thereto, and be done with respect to the character profile(s) 10″ that is(are) assigned with the secondary support status by assigning the suitable entry(entries) of voice style data 201 thereto, but in other embodiments, other orders may be implemented as well.

Specifically, for each of the character profiles 10, the processor 11 first selects one of the voice style groups 20 that corresponds with the character mark 101 of the character profile 10, and then selects one of the entries of voice style data 201 included in the selected one of the voice style groups 20. In such a manner, each of the character profiles 10 may be assigned with an entry of voice style data 201 that corresponds with the character mark 101 of the character profile 10. In the example of FIG. 3, the character profile 10B has the character mark 101 that indicates an adult female, and therefore the processor 11 may select one of the voice style groups 20 that corresponds with the character mark 101 (e.g., the voice style groups 20C or 20D) as a matching voice style group, and selects one of the entries of voice style data 201 included in the matching voice style group to be assigned to the character profile 10B.

In the case that for the character profile 10 that includes the voice style tag 102 and that is assigned with the lead status or the primary support status, in selecting the one of the entries of voice style data 201 included in the matching voice style group, the processor 11 selects one of the entries of voice style data 201 that indicates an audio pitch corresponding with the voice style tag 102.

For example, the character profile 10A as shown in FIG. 3 includes the character mark 101 that indicates an adult male, is assigned with the lead status, and includes the voice style tag 102 indicating a low audio pitch. As such, in assigning one of the entries of voice style data 201 for the character profile 10A, the processor 11 first selects the voice style group 20A as the matching voice style group, and selects one of the entries of voice style data 201 that indicates the low audio pitch to be assigned to the character profile 10A. In some embodiments, after the voice style group 20A is selected as the matching voice style group for the character profile 10A assigned with the lead status, the voice style group 20A may be labeled as a lead character voice style group 20*.

The character profile 10B as shown in FIG. 3 includes the character mark 101 that indicates an adult female, is assigned with the primary support status, and includes the voice style tag 102 indicating a high audio pitch. As such, in assigning one of the entries of voice style data 201 for the character profile 10B, the processor 11 first selects the voice style group 20C as the matching voice style group, and selects one of the entries of voice style data 201 that indicates the high audio pitch to be assigned to the character profile 10B.

In the case that more than one character profile (e.g., 10′) assigned with the primary support status includes the same character mark 101, in selecting the one of the entries of voice style data 201, the processor 11 first determines whether more than one voice style group 20 associated with the same character mark 101 is present, and whether the lead character voice style group 20* is among those voice style groups 20. That is to say, the determination is on whether multiple character profiles 10′ of the plurality of character profiles 10 included in the voice style requirement file D1 have the character marks 101 that are same, and are assigned with the primary support status.

In the case that more than one voice style group 20 associated with the same character mark 101 is present and that the lead character voice style group 20* is not among those voice style groups 20, the processor 11 selects the voice style groups 20 for the character profiles 10′ from the more than one voice style group 20 associated with the same character mark 101 by turns (i.e., in a round robin fashion, from the first to the last of the associated voice style groups then starting again from the first of the associated voice style groups and so on).

For example, the character profiles 10B and 10C as shown in FIG. 3 include the character marks 101 that both indicate an adult female, and are assigned with the primary support status. The processor 11 determines that two voice style groups 20C and 20D are associated with the adult female, and the lead character voice style group 20* (20A) is not among the voice style groups 20C and 20D. As such, in assigning one of the entries of voice style data 201 to a respective one of the character profiles 10B and 10C, the processor 11 first selects the voice style group 20C as the matching voice style group for the character profile 10B and selects one of the entries of voice style data 201 included in the voice style group 20C to be assigned to the character profile 10B. Then, the processor 11 selects the voice style group 20D as the matching voice style group for the character profile 10C and selects one of the entries of voice style data 201 included in the voice style group 20D to be assigned to the character profile 10C.

It is noted that in a case where more character profiles that include the character marks 101 indicating an adult female and that are assigned with the primary support status are present, the processor 11 may select the voice style group 20C as the matching voice style group for a third character profile, select the voice style group 20D as the matching voice style group for a fourth character profile, and so on. In this manner, the method is configured to distribute different voice styles to supporting characters that are relatively important without being repetitive.

On the other hand, in the case that more than one voice style group 20 associated with the same character mark 101 is present and that the lead character voice style group 20* is among those voice style groups 20 (i.e., the more than one voice style group 20 that is associated with the same character mark 101), the processor 11 selects the voice style groups 20 for the character profiles 10′ by excluding the lead character voice style group 20*.

For example, the character profiles 10D and 10E as shown in FIG. 3 include the character marks 101 that indicate an adult male, and are assigned with the primary support status. The processor 11 determines that two voice style groups 20A and 20B are associated with the adult female, and the lead character voice style group 20* (20A) is among the voice style groups 20A and 20B. As such, in assigning one of the entries of voice style data 201 to a respective one of the character profiles 10D and 10E, the processor 11 first selects the voice style group 20B as the matching voice style group for the character profile 10D and selects one of the entries of voice style data 201 included in the voice style group 20B to be assigned to the character profile 10D. Then, the processor 11 selects the voice style group 20B as the matching voice style group for the character profile 10E and selects one of the entries of voice style data 201 included in the voice style group 20B to be assigned to the character profile 10E. In this manner, the method is configured to distribute different voice styles to ensure that the supporting characters do not sound like the lead character.

Then, in selecting one of the entries of voice style data 201 for the character profiles 10″ assigned with the secondary support status, in the case that more than one character profile 10″ assigned with the secondary support status includes the same character mark 101, in selecting the one of the entries of voice style data 201, the processor 11 first determines whether more than one voice style group 20 associated with the same character mark 101 is present. In the case that more than one voice style group 20 associated with the same character mark 101 is present, the processor 11 selects the voice style groups 20 for the character profiles 10″ from the more than one voice style group 20 associated with the same character mark 101 by turns.

For example, the character profiles 10F, 10G and 10H as shown in FIG. 3 include the character marks 101 that indicate an adult female, and are assigned with the secondary support status. The processor 11 determines that two voice style groups 20C and 20D are associated with the adult female. As such, in assigning one of the entries of voice style data 201 to a respective one of the character profiles 10F, 10G and 10H, the processor 11 first selects the voice style group 20C as the matching voice style group for the character profile 10F and selects one of the entries of voice style data 201 included in the voice style group 20C to be assigned to the character profile 10F. Then, the processor 11 selects the voice style group 20D as the matching voice style group for the character profile 10G and selects one of the entries of voice style data 201 included in the voice style group 20D to be assigned to the character profile 10G. Last, the processor 11 selects the voice style group 20C as the matching voice style group for the character profile 10H and selects one of the entries of voice style data 201 included in the voice style group 20C to be assigned to the character profile 10H. In this manner, the method is configured to distribute different voice styles to ensure that the secondary supporting characters do not sound like the lead character, and to ensure that the secondary supporting characters do not sound like one another.

In some embodiments, for each of the character profiles 10″, in selecting one of the entries of voice style data 201 included in the selected voice style group 20, the processor 11 may first determine whether all of the entries of voice style data 201 included in the selected voice style group 20 have been assigned to other character profiles 10. In the case that there exists at least one entry of voice style data 201 included in the selected voice style group 20 that has not yet been assigned to any character profile 10, the processor 11 prioritizes selecting the at least one entry of voice style data 201 that is not yet been assigned to any character profile 10 to have the at least one entry of voice style data 201 assigned to the character profile 10″. In the case that there does not exist any entry of voice style data 201 included in the selected voice style group 20 that has not yet been assigned to another character profile 10, the processor 11 selects one of the entries of voice style data 201 that is least assigned. That is to say, the processor 11 may determine a number of times of assignment related to each of the entries of voice style data 201, and to select one of the entries of voice style data 201 that has the lowest number.

In some embodiments, the operations of step S3 may be first performed with respect to the character profile(s) 10′ that is(are) assigned with the primary support status by assigning the suitable entries of voice style data 201 thereto. In such cases, at least one of the character profiles 10′ included in the voice style requirement file D1 includes the voice style tag 102 indicating a certain audio pitch related to the voice of the character, and is assigned with a primary support status. The operations of step S3 then include, for the at least one of the character profiles 10′, selecting one of the voice style groups 20 as a matching voice style group, and assigning, one of the plurality of entries of voice style data 201 that is associated with the certain audio pitch matching the voice style tag 102 and that is included in the matching voice style group, to the at least one of the character profiles 10′.

In the case that a plurality of the character profiles 10′ that include the same character marks 101 and that are assigned with the primary support status are present, and a plurality of voice style groups 20 associated with the same character marks 101 are present, the operations of step S3 include selecting, for each of the character profiles 10′, one of the voice style groups 20 from the plurality of voice style groups 20 associated with the same character marks 101 by turns.

After the operations of step S3 are completed, the flow proceeds to step S4. It is noted that at this stage, each of the spoken lines included in the text file is associated with one of the character profiles 10 and is indirectly associated with one of the entries of voice style data 201.

In step S4, for each of the character profiles 10″ assigned with the secondary support status, the processor 11 determines whether a voice style conflict condition has occurred based on the text file and a corresponding one of the entries of voice style data 201 that is assigned to the character profile 10″.

Specifically, for each of the character profiles 10″ (hereinafter referred to as a to-be-tested character profile), the processor 11 determines, for each of the associated spoken lines (hereinafter referred to as a to-be-tested spoken line), whether the voice style conflict condition has occurred. In some embodiments, the voice style conflict condition indicates that there exists a neighboring spoken line that is: a) in a neighboring condition; b) associated with a character profile 10 that is different from the to-be-tested character profile; and c) assigned with the same entry of voice style data 201 that is assigned to the to-be-tested character profile. In some embodiments, the neighboring condition indicates that the neighboring spoken line and the to-be-tested spoken line are spaced apart by less than a predetermined threshold (e.g., 600 characters or other numbers of characters based on the text file).

For example, when the character profile 10F is the to-be-tested character profile, the processor 11 may determine a voice style conflict condition occurs in the case that for one of the spoken lines associated with the character profile 10F, another spoken line associated with the character profile 10B (which is assigned with a same entry of voice style data 201 as the character profile 10F) is spaced apart from the one of the spoken lines by less than the predetermined threshold. In such cases, the listeners may hear two different characters “speaking” a same voice style in a relative short period, and may result in confusion. As such, it may be beneficial to identify the potential detrimental dubbing mistake at this stage.

In the case that it is determined that no voice style conflict condition exists for all of the character profiles 10, the flow proceeds to step S9. Otherwise, in the case that at least one voice style conflict condition is detected with respect to the to-be-tested character profile, the flow proceeds to step S5.

In step S5, the processor 11 performs an update operation on the to-be-tested character profile. Specifically, the processor 11 replaces the entry of voice style data 201 that is assigned to the to-be-tested character profile with another entry of voice style data 201 included in the same voice style group 20. This is done in an attempt to eliminate the potential situation that listeners heard two different characters “speaking” a same voice style in a relative short period. In addition, the processor 11 adds one to a value of a counter indicating a number of times the update operation is implemented.

For example, a to-be-tested character profile may be assigned with an entry of voice style data 201 included in the voice style group 20C indicating the low audio pitch. In the case that the voice style conflict condition occurs (i.e., a spoken line associated with another character profile 10 and also assigned to be spoken using the same entry of voice style data 201 is present near one of the to-be-tested spoken lines), the update operation on the to-be-tested character profile may involve assigning another entry of voice style data 201 included in the same voice style group 20C (e.g., the entry of voice style data 201 indicating the middle audio pitch, or a random entry of voice style data 201 included in the same voice style group 20C) to the to-be-tested character profile.

Alternatively, the update operation on the to-be-tested character profile may involve assigning, one entry of voice style data 201 included in another voice style group (e.g., 20D) that is associated with the same character marks 101, as the voice style group (e.g., 20C), which includes the entry of voice style data 201 previously assigned.

After the update operation is implemented, the flow proceeds to step S6, in which the processor 11 determines, for each of the character profiles 10″, whether the voice style conflict condition has occurred. It is noted that the operations of step S6 may be done in a manner similar to those of step S4.

In the case that it is determined that no voice style conflict condition exists for all of the character profiles 10, the flow proceeds to step S9. Otherwise, in the case that at least one voice style conflict condition is detected with respect to the to-be-tested character profile, the flow proceeds to step S7.

In step S7, the processor 11 determines whether the value of the counter has reached a predetermined ceiling (e.g., 3). That is to say, the processor 11 determines whether the update operation has been implemented for the predefined number of times. In the case that it is determined that the value of the counter has reached the predetermined ceiling, the flow proceeds to step S8. Otherwise, the flow goes back to step S5.

In step S8, the processor 11 generates an alert indicating the voice style conflict condition. In some embodiments, the alert includes a screen image that indicates the to-be-tested character profile, and may be displayed by a display screen to notify a user. In some embodiments, the alert may include a text message indicating that the user intervention may be needed to attend to the voice style conflict condition. Then, after the user has addressed the alert by, for example, manually assigning one entry of voice style data 201 to the involved character profiles 10″, expanding the list of voice style groups D2 or adjusting the predetermined threshold, the flow may go back to step S4 again with the counter being reset to zero.

It is noted that in some embodiments, after the voice style conflict condition is detected, the flow may directly proceed to step S8 to generate the alert indicating the voice style conflict condition. In some embodiments, in the case that the voice style conflict condition remains after the update operation has been implemented, the flow may directly proceed to step S8 to generate the alert indicating the voice style conflict condition.

In step S9, the processor 11 generates an assignment result that includes each of the character profiles 10 and the entries of voice style data 201 that have been assigned to the character profiles 10. In some embodiments, the processor 11 may output the assignment result by displaying the assignment result on a display screen and/or transmitting the assignment result to a remote server via a network (e.g., the Internet). Using the text file, the synthesized voice database (DB) and the assignment result, a processor executing the voice synthesization software is capable of generating a speech file of the text file, with all characters being assigned with suitable voice styles. As such, the method is completed.

It is noted that the above description and the illustration of FIG. 2 is merely one specific implementation of the method. As such, in other embodiments, the method may be implemented in manners that are not precisely the same as shown in FIG. 2, while still achieve substantially the same effects in a substantially similar way. That is to say, the implementation as shown in FIG. 2 is not meant to be limiting.

According to one embodiment of the disclosure, a computer program that includes a software program stored in a non-transitory storage medium and including instructions that can be loaded and executed by a processor of an electronic device (e.g., a personal computer, a laptop, a tablet, a smartphone, a server, etc.) is provided. When executed by the processor, the instructions cause the processor to implement the steps of the method as shown in FIG. 2, with the electronic device serving as the system 1 as shown in FIG. 1.

To sum up, the embodiments of the disclosure provide a method for assigning synthesized voice styles to different characters. In the method, after the voice style requirement file D1 is obtained, the processor 11 obtains a list of voice style groups D2 from the synthesized voice database (DB). The list of voice style groups D2 may include derived entries of voice style data 201 that are derived from the synthesized voice database (DB) by adjusting the audio pitch and/or the tempo of an initial entry of voice style data 201 contained in the synthesized voice database (DB), so that the entries of voice style data 201 included in the list of voice style groups D2 are not limited to the initial entry of voice style data 201, expanding the available entries of voice style data 201 to be assigned to different character profiles. In assigning the character profiles with entries of voice style data, the processor 11 ensures that the primary supporting characters do not sound like the lead character, the secondary supporting characters do not sound like the lead character, and the secondary supporting characters do not sound like one another. Then, after assigning each of the character profiles with an entry of voice style data 201, the processor 11 may determine whether a voice style conflict condition has occurred based on the text file and the entries of voice style data 201 assigned to the character profiles, in order to eliminate the potential result of listeners hearing two different characters “speaking” a same voice style in a relative short period. As such, the method is particularly useful in the case that the synthesized voice database (DB) has limited number of entries of voice style data and the number of characters included in the text file is relatively large.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for assigning synthesized voice styles to different characters, the method being implemented using a system that includes a processor, the method comprising steps of:
a) obtaining a voice style requirement file and a list of voice style groups, wherein
the voice style requirement file includes a plurality of character profiles that respectively correspond with a plurality of characters included in a text file, and each of the plurality of character profiles includes a character mark that indicates a type of the respective one of the plurality of characters, and
the list of voice style groups includes a plurality of voice style groups, each of the plurality of voice style groups is associated with one of the character marks of the plurality of character profiles, and includes plural entries of voice style data, each of the plural entries of voice style data is associated with a voice style, and for at least one of the plurality of voice style groups, the plural entries of voice style data include one initial entry of voice style data and at least one derived entry of voice style data that is obtained by performing an audio pitch adjustment operation on the initial entry of voice style data; and
b) establishing an association between each of the plurality of characters included in the text file and a voice style by, for each of the plurality of character profiles, selecting one of the plurality of voice style groups that is associated with the character mark of the character profile as a matching voice style group, and then assigning one of the plural entries of voice style data included in the matching voice style group to the character profile.

2. The method as claimed in claim 1, wherein:
at least one of the plurality of character profiles included in the voice style requirement file includes a voice style tag indicating an audio pitch related to a voice of the respective character, and is assigned with a primary support status, and with respect to each of the plurality of voice style groups, each of the plural entries of voice style data is associated with an audio pitch; and
step b) includes, for the at least one of the plurality of character profiles, selecting one of the plurality of voice style groups as the matching voice style group, and assigning, one of the plural entries of voice style data included in the matching voice style group and associated with the audio pitch that corresponds with the voice style tag, to the character profile assigned with the primary support status.

3. The method as claimed in claim 2, wherein, in a case where multiple character profiles of the plurality of character profiles include the character marks that are same and are assigned with the primary support status, and multiple voice style groups of the plurality of voice style groups are associated with the character marks that are same, step b) includes:
selecting, for each of the multiple character profiles, the one of the plurality of voice style groups from the multiple voice style groups associated with the same character mark by turns.

4. The method as claimed in claim 1, wherein:
one of the plurality of character profiles included in the voice style requirement file is assigned with a lead status, and the one of the plurality of voice style groups selected as the matching voice style group is labeled as a lead character voice style group;
multiple character profiles of the plurality of character profiles included in the voice style requirement file have the character marks that are same, and are assigned with a primary support status; and
step b) further includes
determining whether multiple voice style groups of the plurality of voice style groups are associated with the character marks that are same, and whether the lead character voice style group is among the multiple voice style groups, and
in a case where determination is affirmative, selecting a voice style group for each of the plurality of character profiles assigned with the primary support status by excluding the lead character voice style group.

5. The method as claimed in claim 1, wherein:
multiple character profiles of the plurality of character profiles that do not include a voice style tag are assigned with a secondary support status, and include the character marks that are same; and
step b) further includes
determining whether multiple voice style groups of the plurality of voice style groups are associated with the character marks that are same, and
in a case where determination is affirmative, selecting a voice style group, for each of the multiple character profiles assigned with the secondary support status, from the multiple voice style groups associated with the same character mark by turns.

6. The method as claimed in claim 1, further comprising, after step b):
c) for each of the plurality of character profiles, determining whether a voice style conflict condition has occurred based on the text file and the one of the plural entries of voice style data that is assigned to the character profile, wherein
the text file includes a plurality of spoken lines, each of the plurality of spoken lines being associated with one of the plurality of character profiles and one of the plural entries of voice style data, one of the plurality of spoken lines serving as a to-be-tested spoken line, one of the plurality of character profiles serving as a to-be-tested character profile,
the voice style conflict condition indicates, for the to-be-tested spoken line of the to-be-tested character profile, there exists a neighboring spoken line that is: in a neighboring condition; associated with a character profile that is different from the to-be-tested character profile; and assigned with a same entry of voice style data that is assigned to the to-be-tested character profile, and
the neighboring condition indicates that the neighboring spoken line and the to-be-tested spoken line are spaced apart by less than a predetermined threshold; and
d) in a case where the voice style conflict condition has occurred, generating an alert indicating the voice style conflict condition.

7. The method as claimed in claim 6, further comprising, between steps c) and d):
performing an update operation on the to-be-tested character profile to replace the entry of voice style data that is assigned to the to-be-tested character profile with another entry of voice style data, and determining whether the voice style conflict condition remains; and
implementing step d) in a case where the voice style conflict condition remains.

8. A system comprising a processor and a data storage unit that is connected to the processor and that stores a software application therein, wherein the processor executing the software application is programmed to perform the steps of the method as claimed in claim 1.

9. A computer program product comprising a software program that is stored in a non-transitory storage medium and that includes instructions, which can be loaded and executed by a processor of an electronic device, wherein, when executed by the processor, the instructions cause the processor to implement the steps of the method as claimed in claim 1.
